(19) United States
(12) Patent Application Publication
(10) Pub. No.: US 2025/0219384 A1
(43) Pub. Date: Jul. 3, 2025

(54) AUXILIARY ELECTRIC SPLICE

(71) Applicant: Lear Corporation, Southfield, MI (US)

(72) Inventors: Haisheng Luo, Shanghai (CN); Chao Fang, Shanghai (CN)

(73) Assignee: Lear Corporation, Southfield, MI (US)

(21) Appl. No.: 18/905,465

(22) Filed: Oct. 3, 2024

(30) Foreign Application Priority Data
Dec. 27, 2023 (CN) 202311833262.1

(51) Int. Cl. H02G 15/10

(52) U.S. Cl. CPC H02G 15/10

(57) ABSTRACT

An auxiliary electric splice including an insulator assembly having first and second insulators configured to electrically insulate electrical splice joints. The first insulator including: a support wall configured to extend longitudinally adjacent to the splice joints; a center insulator plate extending laterally from the support wall and configured to extend between the splice joints; a first outer insulator plate extending laterally from the support wall, spaced from the center insulator plate, and including a pair of end plate stiffening flanges that extend laterally and a pair of drawer runner flanges, each extending from a respective one of the end plate stiffening flanges to define a cavity for receiving a portion of the second insulator; and a second outer insulator plate extending laterally from the support wall, spaced from the center insulator plate on an opposite side from the first outer insulator plate, configured to engage with the second insulator.

### FIELD

This disclosure relates generally to the field of electric cables. More particularly, the disclosure relates to an auxiliary splice for connecting electric cables.

### BACKGROUND

Auxiliary splices are used to selectively connect and disconnect electrical conductors in a circuit, for example a high voltage electric circuit in an automotive vehicle. A housing and insulators may be employed in the auxiliary splices to retain and insulate the electric conductors being spliced. It is desirable to have a low cost and easy to assemble housing and insulator assembly. Additionally, it is desirable, when assembled for one to be able to see that a housing containing the auxiliary splice is locked in an assembled position when in use.

### SUMMARY

According to an aspect, an embodiment provides an auxiliary electric splice for connecting electric cables at splice joints, the auxiliary electric splice comprising: an insulator assembly comprising a first insulator and a second insulator configured to secure around and between the splice joints to electrically insulate the splice joints, the first insulator including: a support wall configured to extend longitudinally adjacent to the splice joints; a center insulator plate extending laterally from the support wall and configured to extend between the splice joints; a first outer insulator plate extending laterally from the support wall, spaced from the center insulator plate, and including a pair of end plate stiffening flanges that extend laterally and a pair of drawer runner flanges, each extending from a respective one of the end plate stiffening flanges to define a cavity for receiving a portion of the second insulator; and a second outer insulator plate extending laterally from the support wall, spaced from the center insulator plate on an opposite side from the first outer insulator plate, configured to engage with the second insulator.

According to an aspect, an embodiment provides an auxiliary electric splice for connecting electric cables at splice joints, the auxiliary electric splice comprising: an insulator assembly comprising a first insulator and a second insulator configured to secure around and between the splice joints to electrically insulate the splice joints, the first insulator including: a support wall configured to extend longitudinally adjacent to the splice joints; a center insulator plate extending laterally from the support wall and configured to extend between the splice joints; a first outer insulator plate extending laterally from the support wall, spaced from the center insulator plate, and including a catch hole configured to engage the second insulator; and a second outer insulator plate extending laterally from the support wall, spaced from the center insulator plate on an opposite side from the first outer insulator plate, and including a barb configured to engage with the second insulator to hold the first insulator and the second insulator in an assembled position.

According to an aspect, an embodiment provides an integrated housing and holder structure to reduce parts and assembly and disassembly time. According to an aspect an embodiment provides an outside locking feature between the housing and housing end cap to provide a visual assurance that the two are fully locked together and provide for ease of disassembly. According to an aspect, an embodiment provides cable claws to releasably lock the electric cables to the housing and housing end cap, which provides strain relief. According to an aspect, an embodiment provides an insulator assembly that provides an ease of assembly, with insulator plates that will not tend to warp to prevent catches from disengaging while assembled, lead-in flanges for guiding the electric conductors adjacent to the splice joints and essentially identical first and second insulators that mate together to simplify part selection and assembly.

Additional understanding of these examples can be obtained by review of the detailed description below, and the appended drawings.

### BRIEF DESCRIPTION OF THE DRAWINGS

FIG. 1 is a schematic, perspective view of an auxiliary electric splice.

FIG. 2 is a schematic, partially exploded, perspective view of an auxiliary spice, but with only a portion of the electric cables shown.

FIG. 3 is a schematic, perspective view of electric cables and an insulator assembly prior to the insulator assembly being assembled to the electric cables.

FIG. 4 is a schematic, perspective view of part of an insulator assembly.

FIG. 5 is a schematic, perspective view of part of an insulator assembly.

FIG. 6 is a schematic, partially sectioned view of an insulator assembly.

FIG. 7 is a schematic, partially sectioned view of an insulator assembly prior to being assembled.

FIG. 8 is a schematic, perspective view of electric cables and an insulator assembly assembled to the electric cables.

FIG. 9 is a schematic, perspective view of a portion of a housing and a housing end cap before being assembled to the housing.

FIG. 10 is a schematic, perspective view of a housing end cap.

FIG. 11 is a schematic, perspective view of electric cables, cable claws, and cable retention brackets.

### DETAILED DESCRIPTION

The following detailed description and the appended drawings describe and illustrate various example embodiments of an auxiliary electric splice. The description and illustration of these examples are provided to enable one skilled in the art to make and use an auxiliary electric splice according to this invention. They are not intended to limit the scope of the claims in any manner.

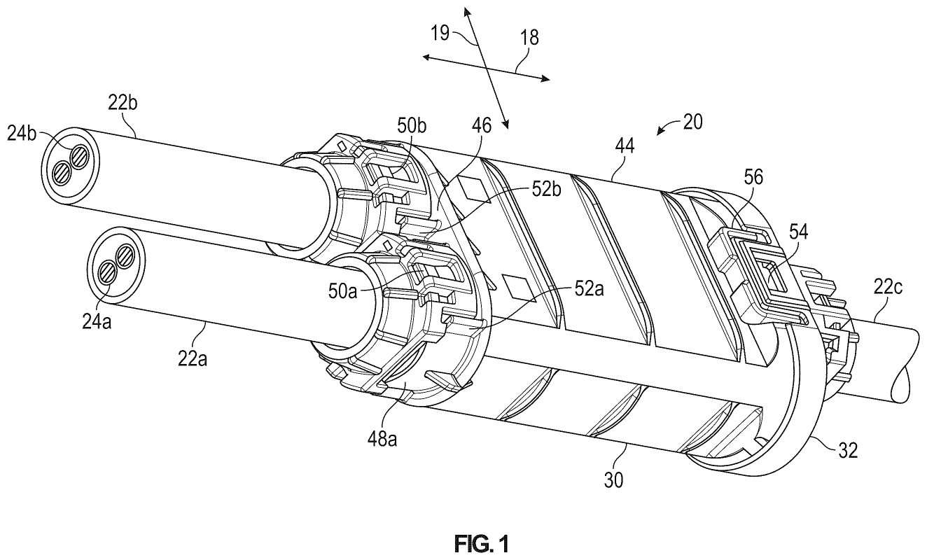

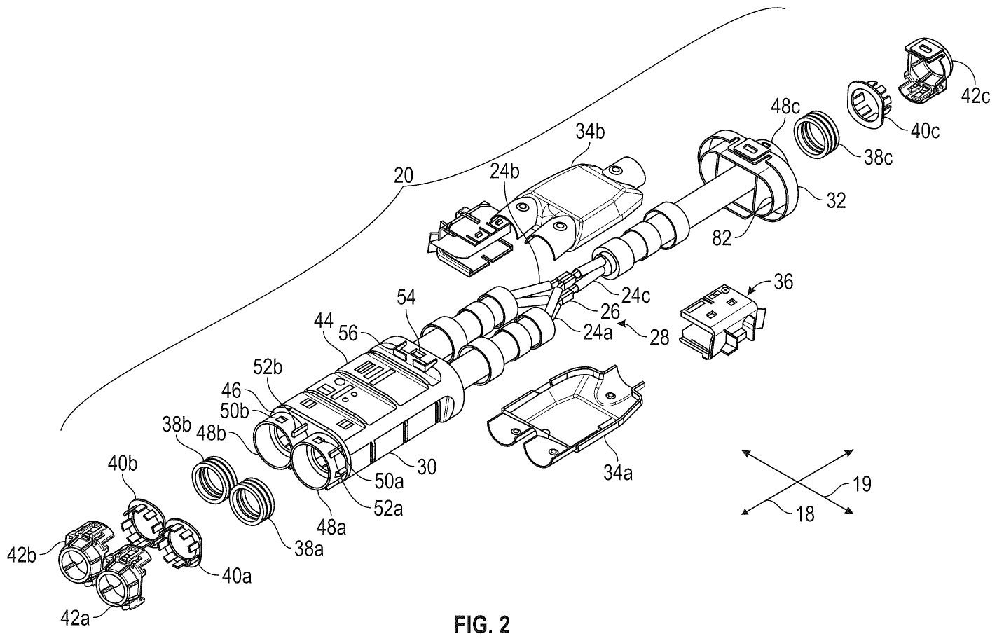

An example is illustrated in FIGS. 1 and 2 of an auxiliary electric splice 20, which is configured to splice electric cables 22a, 22b, 22c. The auxiliary electric splice 20 may be used, for example, in high voltage (e.g., 48 volts, 100 volts, 300 volts or higher). The electric cables 22a, 22b, 22c each include a pair of electrical conductors 24a, 24b, 24c, which are mated at a pair of splice joints 26. The pair of splice joints 26 are contained in a splice assembly 28. For purposes of clarity of description herein, a longitudinal direction 18 is indicated by arrows marked 18 and a lateral direction 19 is indicated by arrows marked 19 in the figures. Thus, the electric cables 22a, 22b, 22c extend essentially in the longitudinal direction 18.

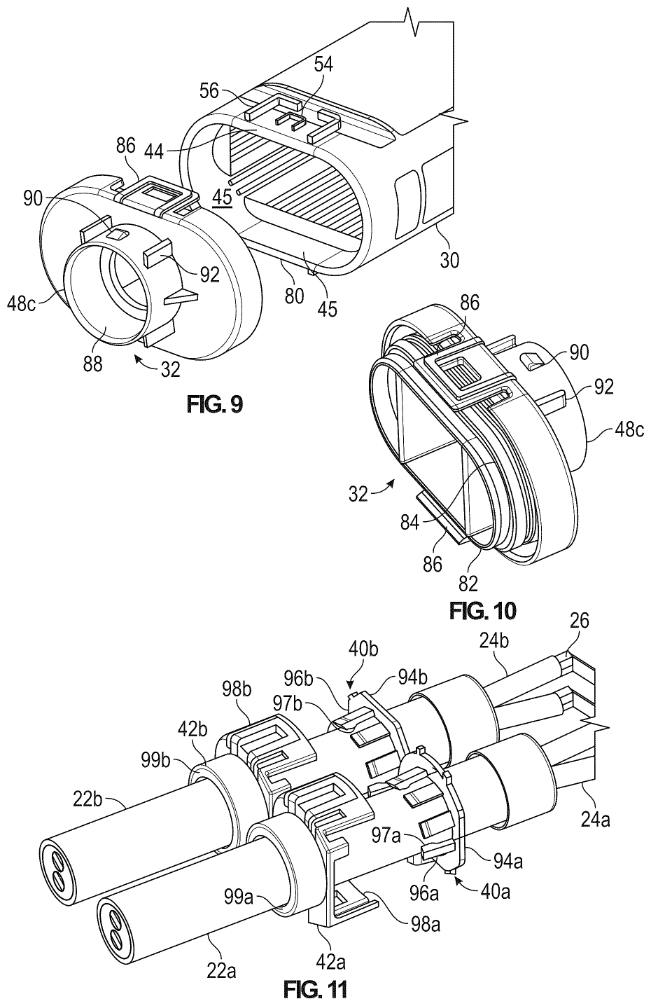

The splice assembly 28 includes a housing 30, a housing end cap 32, internal housing members 34a, 34b, an insulator assembly 36, seals 38a, 38b, 38c, annularly spaced cable claws 40a, 40b, 40c, and cable retention brackets 42a, 42b, 42c. The housing 30 includes an outer wall 44 defining a cavity 45 (best seen in FIG. 9) into which the electric cables 22a, 22b, 22c extend. Integral with the outer wall 44, at a first longitudinal end 46 are holders 48a, 48b, with the first holder 48a shaped to receive and support the first electric cable 22a and the second holder 48b shaped to receive and support the second electric cable 22b. The term integral, as used herein, means that the elements that are integral are a single monolithic part, which may be formed (e.g., molded) as a single part or formed separately and permanently affixed (e.g., adhesive) so as to be a single monolithic part. The outer wall 44 and holders 48a, 48b being integral reduces the number of parts and complexity of assembly when one assembles the auxiliary electrical splice 20. Each of the holders 48a, 48b includes respective cable retention catches 50a, 50b and alignment flanges 52a, 52b. Mounted within each of the holders 48a, 48b is a corresponding one of the seals 38a, 38b, which each surround a respective one of the electric cables 22a, 22b. The outer wall 44 also includes latch engagement catches 54 (one shown on a first side and an essentially identical one on an opposed side of the outer wall 44). Adjacent to each latch engagement catch 54 is a corresponding guide flange 56.

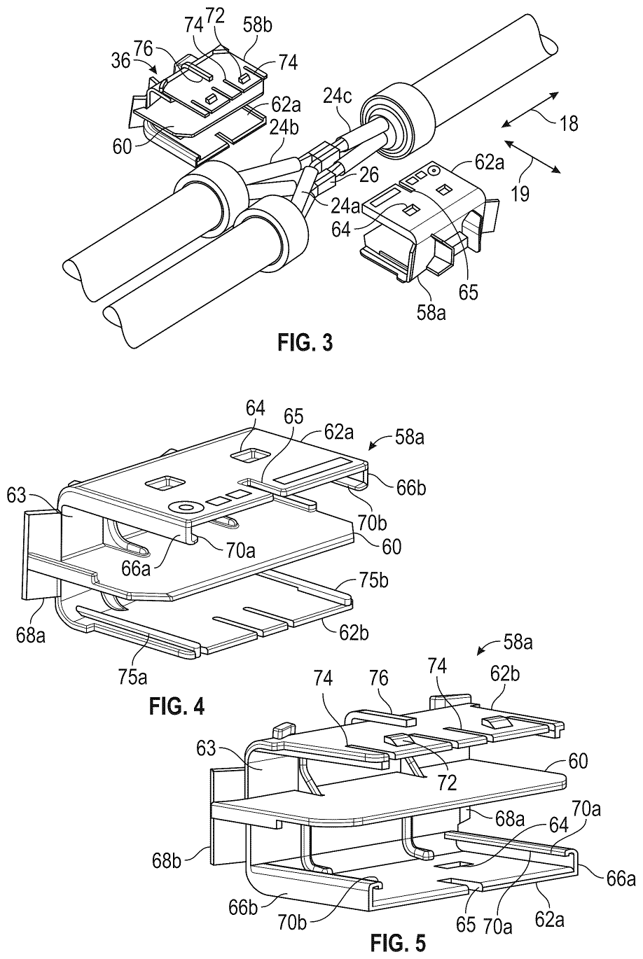

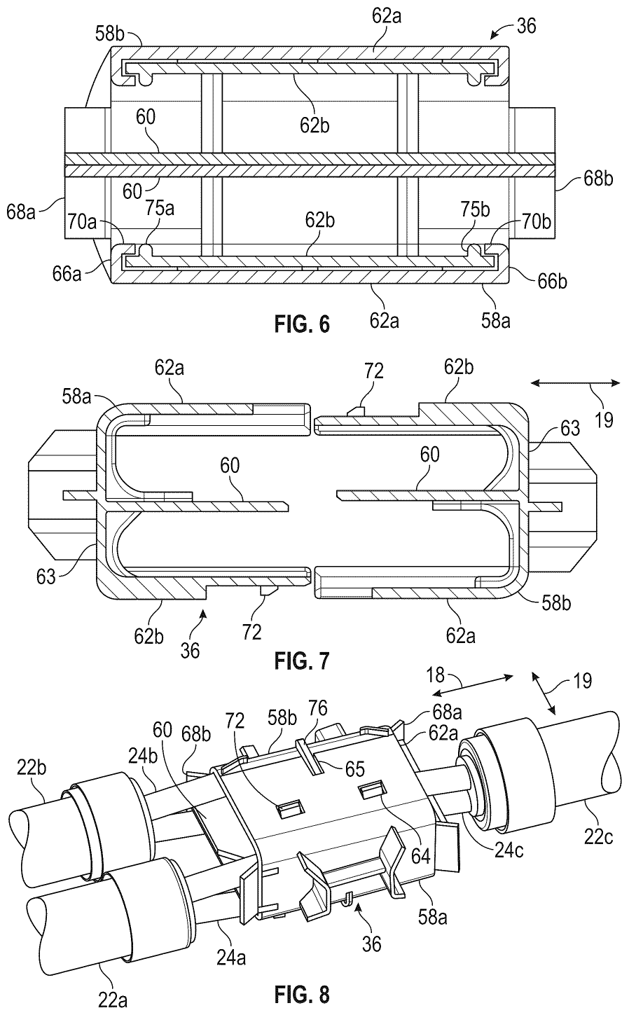

Referring now to the example illustrated in FIGS. 3-8, in view of FIGS. 1 and 2, the insulator assembly 36 includes a first insulator 58a and a second insulator 58b, which may be formed of an electrically non-conductive material (e.g., plastic). The first and second insulators 58a, 58b may be essentially the same size and shape, with one flipped upside down relative to the other and with their open ends facing each other (as best seen in FIGS. 3 and 8). Since the two insulators 58a, 58b are essentially the same, the features of just one insulator will be discussed but with the discussion applying to both insulators 58a, 58b.

The insulator 58a includes a center insulator plate 60, a first outer insulator plate 62a, and a second outer insulator plate 62b, which outer insulator plates 62a, 62b are located on either side of and spaced apart from the center insulator plate 60. The insulator plates 60, 62a, 62b are connected by a support wall 63, which is generally normal to the plates 60, 62a, 62b. The first outer insulator plate 62a includes a pair of catch holes 64 and an alignment notch 65. Extending along opposed edges of the first outer insulator plate 62a are end plate stiffening flanges 66a, 66b, which extend generally perpendicular to the first outer insulator plate 62a toward the center insulator plate 60. Extending from each of the end plate stiffening flanges 66a, 66b are respective drawer runner flanges 70a, 70b. The drawer runner flanges 70a, 70b extend generally perpendicular from the respective end plate stiffening flanges 66a, 66b and parallel to but spaced from the outer insulator plate 62a. The support wall 63 includes lead-in flanges 68a, 68b at opposite longitudinal 18 ends. The lead-in flanges 68a, 68b angle away from the center insulator plate 60 as they extend away from the support wall 63. The second outer insulator plate 62b includes a pair of barbs 72, each located to align with and engage a respective one of the catch holes 64 on a mating insulator 58a or 58b, as the case may be, when the pair of insulators 58a, 58b are fully assembled in the insulator assembly 36. Two pair of flexing slots 74 are located in the second outer insulator plate 62b, with each pair of flexing slots 74 being located on opposite sides of the corresponding barb 72. This allows for local flexing of the second outer insulator plate 62b during assembly. The second outer insulator plate 62b includes a plate alignment flange 76, which is located to align with and engage the alignment notch 65 on a mating insulator 58a or 58b, as the case may be, when the pair of insulators 58a, 58b are fully assembled in the insulator assembly 36. The second outer insulator plate 62b also includes a pair of drawer alignment flanges 75 that are configured to assist in retaining the second outer insulator plate 62b in the drawer runner flanges 70a, 70b.

Assembly of the two insulators 58a, 58b will now be discussed. The first insulator 58a is aligned with an open side (side opposite the support wall 63) facing the electrical conductors 24a, 24b, 24c (as best illustrated in FIG. 3). The second insulator 58b is aligned with its open side facing the electrical conductors 24a, 24b, 24c, but from the opposite side of the electrical conductors 24a, 24b, 24c, and flipped so that its first outer insulator plate 62a aligns with the second outer insulator plate 62b of the first insulator 58a and its second outer insulator plate 62b aligns with the first outer insulator plate 62a of the first insulator 58a (as best illustrated in FIG. 3). The first and second insulators 58a, 58b are aligned with the electrical conductors 24a, 24b, 24c so that the center insulator plate 60 of each will slide between the splice joints 26 (as best illustrated in FIGS. 3 and 7). The first and second insulators 58a, 58b are also aligned so that the second insulator's 58b second outer insulator plate 62b will slide between the first outer insulator plate 62a and the drawer runner flanges 70a, 70b of the first outer insulator plate 62a and its first outer insulator plate 62a and its drawer runner flanges 70a, 70b will slide around the second outer insulator plate 62b of the first insulator 58a (as best seen in FIG. 7). The first and second insulators 58a, 58b are then slid laterally towards each other, with the flexing slots 74 allowing the barbs 72 to flex until the barbs 72 align with their respective catch holes 64 (as best seen in FIGS. 7 and 8). The insulator assembly 36 is now secured around the splice joints 26.

Referring now to the example illustrated in FIGS. 9 and 10, in view of FIGS. 1 and 2, a portion of the housing 30 and the associated housing end cap 32 are shown. The latch engagement catches 54 (one shown in FIG. 9) and the guide flanges 56 extend outward from the outer wall 44 adjacent to an opening at a second longitudinal end 80 of the cavity 45 defined by the outer wall 44. The housing end cap 32 includes an internal flange 82 extending around a periphery that is sized and shaped to slide within the cavity 45 so that a seal 84 mounted around the internal flange 82 seals against an inner surface of the outer wall 44 of the housing 30. The housing end cap 32 also includes a pair of outer flange locks 86, with each configured to mate with a respective one of the lock engagement catches 54 to secure the housing end cap 32 to the outer wall 44 of the housing 30. A third cable holder 48c extends around a passage 88 through which the electric cable 22c extends. The third cable holder 48c includes cable retention catches 90 and alignment flanges 92 configured to mate with the third cable retention bracket 42c.

Referring now to the example illustrated in FIG. 11, with reference to FIGS. 1 and 2, the cable claws 40a, 40b and cable retention brackets 42a, 42b are shown mounted around respective electric cables 22a, 22b, with the corresponding pairs of electric conductors 24a, 24b extending to the splice joints 26. The cable claws 40a, 40b each include an annular support 94a, 94b, with respective sets of longitudinally extending claw arms 96a, 96b extending therefrom. Each of the claw arms 96a, 96b has a radially inwardly extending nib 97a, 97b that is configured to engage the outer surface of the respective electric cable 22a, 22b. Each of the cable retention brackets 42a, 42b include a pair of retention arms 98a, 98b, which are configured to engage the corresponding cable retention catches 50a, 50b to retain the cable retention brackets 42a, 42b to the housing 30. Each of the cable retention brackets 42a, 42b also include an annular body 99a, 99b surrounding a respective one of the electric cables 22a, 22b. The cable claw 40c and cable retention bracket 42c may be essentially the same as the cable claws 40a, 40b and retention brackets 42a, 42b and so will not be separately discussed in detail herein.

Referring now to the example illustrated in FIGS. 1-11, the assembly of the auxiliary electric splice 20 will now be discussed. The electric cable 22a is slid through the cable retention bracket 42a, the cable claw 40a, the seal 38a, holder 48a, and the cavity 45. The same assembly steps occur with the electric cable 22b. The electric cable 22c is slid through the cable retention bracket 42c, the cable claw 40c, the seal 38c, the holder 48c and the housing end cap 32. The pairs of electric conductors 24a, 24b and 24c are connected together (as best seen in FIGS. 2 and 3). The insulator assembly 36 is then assembled, as discussed above to ensure that the splice joints 26 remain electrically separated. Then the internal housing members 34a, 34b are assembled together around the splice joints 26, splice assembly 28 and the ends of the electric cables 22a, 22b, 22c. The housing 30 and housing end cap 32 are then slid longitudinally 18 toward each other, with the respective guide flanges 56 guiding the outer flange locks 86 into engagement with the corresponding latch engagement catches 54. Since the latch engagement catches 54 are outside of the housing 30 and visible to an assembler, the assembler may assure that the housing end cap 32 is locked to the housing 30. The seals 38a, 38b, 38c are slid along the corresponding electric cables 22a, 22b, 22c and into the corresponding holders 48a, 48b, 48c. The cable claws 40a, 40b, 40c are slid along the respective electric cables 22a, 22b, 22c up against the corresponding holders 48a, 48b, 48c. The cable retention brackets 42a, 42b, 42c are slid along the respective electric cables 22a, 22b, 22c until the retention arms 98a, 98b, 98c each engage the respective cable retention catches 50a, 50b, 50c. As the cable retention brackets 42a, 42b, 42c are slid into position, the nibs 97a, 97b, 97c of the claw arms 96a, 96b, 96c will be pressed radially inward into engagement with the respective electric cable 22a, 22b, 22c, thus securing the position of the electric cables 22a, 22b, 22c relative to the housing 30 and housing end cap 32.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An auxiliary electric splice for connecting electric cables at splice joints, the auxiliary electric splice comprising:
an insulator assembly comprising a first insulator and a second insulator configured to secure around and between the splice joints to electrically insulate the splice joints, the first insulator including:
a support wall configured to extend longitudinally adjacent to the splice joints;
a center insulator plate extending laterally from the support wall and configured to extend between the splice joints;
a first outer insulator plate extending laterally from the support wall, spaced from the center insulator plate, and including a pair of end plate stiffening flanges that extend laterally and a pair of drawer runner flanges, each extending from a respective one of the end plate stiffening flanges to define a cavity for receiving a portion of the second insulator; and
a second outer insulator plate extending laterally from the support wall, spaced from the center insulator plate on an opposite side from the first outer insulator plate, configured to engage with the second insulator.

2. The auxiliary electric splice of claim 1 wherein the second insulator includes:
a second support wall configured to extend longitudinally adjacent to the splice joints;
a second center insulator plate extending laterally from the second support wall and configured to extend between the splice joints;
a third outer insulator plate extending laterally from the second support wall, spaced from the second center insulator plate, and including a second pair of end plate stiffening flanges that extend laterally and a second pair of drawer runner flanges, each extending from a respective one of the second pair of end plate stiffening flanges to define a second cavity that receives the second outer insulator plate; and
a fourth outer insulator plate extending laterally from the second support wall, spaced from the second center insulator plate on an opposite side from the third outer insulator plate, the fourth outer insulator plate received within the cavity of the first outer insulator plate.

3. The auxiliary electric splice of claim 2 wherein the second outer insulator plate slides laterally between the third outer insulator plate and the second pair of end plate stiffening flanges to retain the second outer insulator plate against the third outer insulator plate, and the fourth outer insulator plate slides laterally between the first outer insulator plate and the drawer runner flanges to retain the fourth outer insulator plate against the first outer insulator plate.

4. The auxiliary electric splice of claim 2 wherein one of the first outer insulator plate and the second outer insulator plate include a catch hole and the other of the first outer insulator plate and the second outer insulator plate include a barb, and one of the third outer insulator plate and the fourth outer insulator plate include a second catch hole and the other of the third outer insulator plate and the fourth outer insulator plate include a second barb, wherein when the first insulator is assembled to the second insulator, the catch hole engages and retains the second barb and the second catch hole engages and retains the barb to secure the first insulator to the second insulator.

5. The auxiliary electric splice of claim 4 wherein the other of the first outer insulator plate and the second outer insulator plate include a pair of laterally extending flexing slots adjacent to and on opposite sides of the barb, and the other of the third outer insulator plate and the fourth outer insulator plate include a second pair of laterally extending flexing slots adjacent to and on opposite sides of the second barb, wherein when the first insulator is assembled to the second insulator, the pair of flexing slots and the second pair of flexing slots allow the barb and the second barb to flex toward the center insulator plate until the barb aligns with the second catch hole and the second barb aligns with the catch hole.

6. The auxiliary electric splice of claim 2 wherein the first outer insulator plate includes an alignment notch, extending laterally, and the fourth outer insulator plate includes a plate alignment flange, extending laterally and configured to engage the alignment notch as the first insulator and the second insulator are moved laterally toward each other to become fully assembled.

7. The auxiliary electric splice of claim 1 wherein the support wall includes two lead-in flanges, each extending from opposed longitudinal ends of the support wall, and each of the lead-in flanges oriented to angle away from the center insulator plate as the lead-in flange extends away from the support wall.

8. The auxiliary electric splice of claim 1 wherein one of the first outer insulator plate and the second outer insulator plate include a catch hole configured to engage with the second insulator, and the other of the first outer insulator plate and the second outer insulator plate include a barb configured to engage with the second insulator.

9. The auxiliary electric splice of claim 1 wherein one of the first outer insulator plate and the second outer insulator plate include an alignment slot, extending laterally and configured to engage with the second insulator, and the other of the first outer insulator plate and the second outer insulator plate include a plate alignment flange, extending laterally and configured to engage with the second insulator.

10. The auxiliary electric splice of claim 1 wherein the second insulator is identical to the first insulator.

11. The auxiliary electric splice of claim 1 further comprising:
a housing having an outer wall configured to contain the splice joints and including one of a latch engagement catch and an outer flange lock on an outside surface of the outer wall; and
a housing end cap configured to cover an end of the housing and including the other of the latch engagement catch and the outer flange lock on an outer surface of the housing end cap, wherein the latch engagement catch and the outer flange lock are configured to releasably engage to secure the housing end cap to the housing.

12. The auxiliary electric splice of claim 11 further comprising a guide flange adjacent to the latch engagement catch and configured to guide the outer flange lock into engagement with the latch engagement catch as the housing end cap is assembled to the housing.

13. The auxiliary electric splice of claim 1 further comprising:
a housing having an outer wall configured to contain the splice joints and an electric cable holder integral with the housing, with the electric cable holder configured to receive and support the electric cables.

14. The auxiliary electric splice of claim 1 further comprising:
a housing end cap including an electric cable holder integral with the housing end cap, with the electric cable holder configured to receive and support one of the electric cables.

15. The auxiliary electric splice of claim 1 further comprising:
a housing having an outer wall configured to contain the splice joints; and
cable claws configured to surround one of the electric cables and secure the one of the electric cables to the housing.

16. The auxiliary electric splice of claim 15 wherein the cable claws includes an annular support surrounding the one of the electric cables, claw arms extending longitudinally from the annular support, and nibs, one each on an end of respective ones of the claw arms, wherein the nibs are configured to press against an outer surface of the one of the electric cables to thereby secure the one of the electric cables to the housing.

17. An auxiliary electric splice for connecting electric cables at splice joints, the auxiliary electric splice comprising:
an insulator assembly comprising a first insulator and a second insulator configured to secure around and between the splice joints to electrically insulate the splice joints, the first insulator including:
a support wall configured to extend longitudinally adjacent to the splice joints;
a center insulator plate extending laterally from the support wall and configured to extend between the splice joints;
a first outer insulator plate extending laterally from the support wall, spaced from the center insulator plate, and including a catch hole configured to engage the second insulator; and
a second outer insulator plate extending laterally from the support wall, spaced from the center insulator plate on an opposite side from the first outer insulator plate, and including a barb configured to engage with the second insulator to hold the first insulator and the second insulator in an assembled position.

18. The auxiliary electric splice of claim 17 wherein the second insulator is identical to the first insulator.

19. The auxiliary electric splice of claim 17 wherein one of the first outer insulator plate and the second outer insulator plate include an alignment slot, extending laterally and configured to engage with the second insulator, and the other of the first outer insulator plate and the second outer insulator plate include a plate alignment flange, extending laterally and configured to engage with the second insulator.

20. An auxiliary electric splice for connecting electric cables at splice joints, the auxiliary electric splice comprising:
an insulator assembly comprising a first insulator and a second insulator configured to secure around and between the splice joints to electrically insulate the splice joints, the first insulator including:
a support wall configured to extend longitudinally adjacent to the splice joints;
a center insulator plate extending laterally from the support wall and configured to extend between the splice joints;
a first outer insulator plate extending laterally from the support wall, spaced from the center insulator plate, and including a pair of end plate stiffening flanges and a catch hole configured to engage the second insulator, the pair of end plate stiffening flanges extending from a respective one of the end plate stiffening flanges to define a cavity for receiving a portion of the second insulator; and
a second outer insulator plate extending laterally from the support wall, spaced from the center insulator plate on an opposite side from the first outer insulator plate, and including a barb configured to engage with the second insulator to hold the first insulator and the second insulator in an assembled position;
wherein the second insulator is identical to the first insulator.
